(19) United States
(12) Patent Application Publication
(10) Pub. No.: US 2015/0123351 A1
(43) Pub. Date: May 7, 2015

(54) BUFFER RING

(71) Applicant: NOK CORPORATION, Tokyo (JP)

(72) Inventor: Takafumi Nakamura, Kitaibaraki-shi (JP)

(73) Assignee: NOK Corporation, Tokyo (JP)

(21) Appl. No.: 14/400,828

(22) PCT Filed: Mar. 26, 2013
(86) PCT No.: PCT/JP2013/058750

§ 371 Date: Nov. 13, 2014

(30) Foreign Application Priority Data
May 16, 2012 (JP) 2012-112669

(51) Int. Cl. F16J 15/32; F15B 15/14

(52) U.S. Cl. CPC F16J 15/3232; F15B 15/1423
USPC 277/562

(57) ABSTRACT

A buffer ring includes an annular body portion 11 that makes close contact with a side wall face 131b of an annular groove 131; an inner peripheral lip 12 that extends toward a sealed fluid side O from an inner peripheral end portion of the body portion 11; and an outer peripheral lip 13 that extends toward the sealed fluid side O from an outer peripheral end portion of the body portion 11 and having an outer peripheral end portion making close contact with a groove bottom face 131a of the annular groove 131, the outer peripheral lip 13 being lower in stiffness than the inner peripheral lip 12, wherein a plurality of protrusions 14 that make close contact with the groove bottom face 131a of the annular groove 131 are provided on an outer peripheral face of the body portion 11 at intervals in a circumferential direction.

### CROSS-REFERENCE TO RELATED APPLICATIONS

This application is a National Stage of International Application No. PCT/JP2013/058750, filed Mar. 26, 2013, which claims priority to Japanese Application No. 2012-112669, filed May 16, 2012. The entire disclosures of each of the above applications are incorporated herein by reference.

### FIELD

The present disclosure relates to a buffer ring to buffer the pressure of a sealed fluid.

### BACKGROUND

Conventionally, a sealing system in which a plurality of seals are combined is used in a hydraulic cylinder or the like that is provided in various industrial equipment (e.g., construction equipment). In such a sealing system, there is known a system including a packing (e.g., U-packing) that seals an annular gap between a piston rod (shaft) and a cylinder (housing), and a buffer ring that is disposed on a sealed fluid side of the packing and buffers the pressure of the sealed fluid against the packing.

With reference to FIG. 6, a buffer ring according to the conventional art will be described. FIG. 6 is a schematic cross-sectional view showing the fixed state of the buffer ring according to the conventional art. As shown in the drawing, a buffer ring 200 is fixed in an annular groove 131 provided on an inner periphery of a shaft hole of a cylinder 130. The buffer ring 200 includes an inner peripheral lip 220 that is slidable relative to a piston rod 110 and an outer peripheral lip 230 that makes close contact with a groove bottom face 131a of the annular groove 131. In addition, an annular notch 240 is provided on an inner peripheral end edge on an air side A of the buffer ring 200. A backup ring 300 is fixed to the annular notch 240. With this, the portion of the inner peripheral end edge on the air side A of the buffer ring 200 is prevented from being protruded into an annular minute gap between the piston rod 110 and the cylinder 130.

The buffer ring 200 configured as above receives and buffers a fluid pressure (oil pressure) on a sealed fluid side O, and it is thereby possible to improve durability of a packing (not shown) provided on the air side A of the buffer ring 200.

In addition, a plurality of grooves 220a are provided on the tip on the sealed fluid side O of the inner peripheral lip 220, and hence, even when the inner peripheral lip 220 makes close contact with a side wall face 131c on the sealed fluid side O of the annular groove 131, a fluid channel is secured.

However, in the case of the buffer ring 200 configured as above, due to an oil pressure pulsation or a reciprocating movement of the piston rod 110, the behavior of the buffer ring 200 has sometimes become unstable within the annular groove 131. FIG. 7 is a schematic cross-sectional view showing a state of the buffer ring according to the conventional art in which its behavior is unstable. As shown in the drawing, there has been a case where the buffer ring 200 is tilted in such a way that the outer peripheral lip 230 moves toward the side wall face 131c on the sealed fluid side O. Because of this, there has been a possibility that sealing performances of the inner peripheral lip 220 and the outer peripheral lip 230 become unstable, and hence the function of the buffer ring 200 is not sufficiently performed. Consequently, there has been concern that the sealing performance of the entire sealing system may be declined.

### CITATION LIST

### Patent Literature

Patent Document 1: Japanese Patent Application Laid-open No. 2001-221343

### Summary Technical Problem

An object of the present disclosure is to provide a buffer ring that is capable of stably performing a buffering function by stabilizing its behavior.

### Solution to Problem

The present disclosure has adopted the following means in order to solve the above problem.

That is, a buffer ring of the present disclosure is a buffer ring to buffer a pressure of a sealed fluid against a packing that seals an annular gap between a shaft and a housing reciprocating relative to each other, the buffer ring being fixed on a sealed fluid side of the packing and in an annular groove provided on an inner periphery of the housing, the buffer ring characterized by comprising: an annular body portion that makes close contact with a side wall face of the annular groove; an inner peripheral lip that extends toward a sealed fluid side from an inner peripheral end portion of the body portion, an inner peripheral end portion of the inner peripheral lip being slidable relative to an outer peripheral face of the shaft; and an outer peripheral lip that extends toward the sealed fluid side and an outer peripheral side so as to be inclined from an outer peripheral end portion of the body portion, an outer peripheral end portion of the outer peripheral lip making close contact with a groove bottom face of the annular groove, the outer peripheral lip being lower in stiffness than the inner peripheral lip, wherein a plurality of protrusions that make close contact with the groove bottom face of the annular groove are provided on an outer peripheral face of the body portion at intervals in a circumferential direction.

According to the present disclosure, since the plurality of protrusions that make close contact with the groove bottom face of the annular groove are provided on the outer peripheral face of the body portion at intervals in the circumferential direction, it is possible to prevent the entire buffer ring from falling over in such a way as to tilt. As a result, it is possible to stabilize the posture of the buffer ring with respect to the annular groove. Accordingly, it is possible to make the function of the buffer ring be stably performed.

### Advantageous Effects of Disclosure

As described above, according to the present disclosure, it is possible to stabilize the behavior of the buffer ring and make its buffering function be stably performed.

### DRAWINGS

FIG. 1 is a partially exploded perspective view of a hydraulic cylinder;

FIG. 2 is a schematic cross-sectional view of a sealing system according to an example of the present disclosure;

FIG. 3 is a schematic cross-sectional view of a buffer ring according to the example of the present disclosure;

FIG. 4 is a view showing a part of an outer peripheral face of the buffer ring according to the example of the present disclosure;

FIG. 5 is a schematic cross-sectional view showing the fixed state of the buffer ring according to the example of the present disclosure;

FIG. 6 is a schematic cross-sectional view showing the fixed state of a buffer ring according to the conventional art; and

FIG. 7 is a schematic cross-sectional view showing a state a state of the buffer ring according to the conventional art in which its behavior is unstable.

### DETAILED DESCRIPTION

Hereinbelow, with reference to the drawings, a mode for carrying out the disclosure will be described in detail by way of example based on an embodiment. However, the scope of the present disclosure is not limited only to dimensions, materials, shapes, and relative arrangements of constituent parts described in the embodiment unless specifically described.

### EXAMPLE

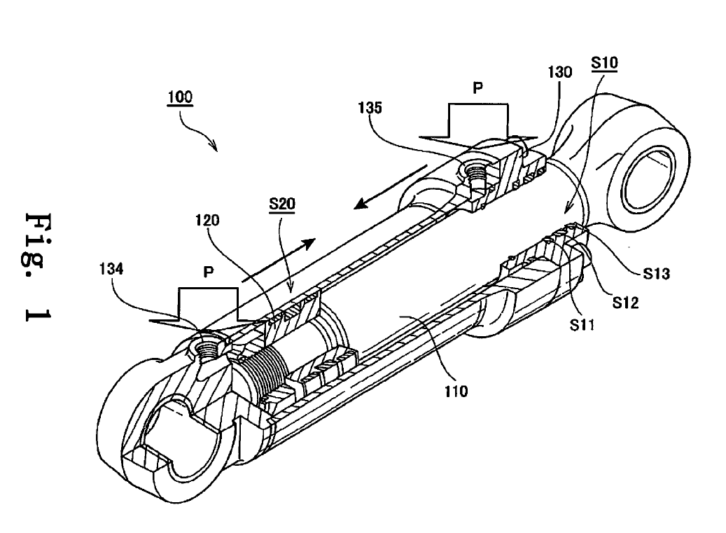

With reference to FIGS. 1 to 5, a buffer ring according to the example of the present disclosure will be described.

<Hydraulic Cylinder>

With reference to FIG. 1, the configuration of an entire hydraulic cylinder including a buffer ring will be described. FIG. 1 is a partially exploded perspective view of the hydraulic cylinder.

A hydraulic cylinder 100 comprises a piston rod 110 as a shaft to which a piston 120 is fixed, and a cylinder 130 as a housing. The piston rod 110 and the cylinder 130 are configured to reciprocate relative to each other. More specifically, by controlling an oil pressure via two ports 134 and 135 provided in the cylinder 130 (controlling the oil pressure in the directions of arrows P in the drawing), it is possible to cause the piston 120 and the piston rod 110 to reciprocate relative to the cylinder 130.

The hydraulic cylinder 100 is provided with a first sealing system S10 that seals an annular gap between the piston rod 110 and the cylinder 130, and a second sealing system S20 that seals an annular gap between the piston 120 and the cylinder 130. The inside of the hydraulic cylinder 100 is sealed from the outside by the first sealing system S10, and two sealed regions in the hydraulic cylinder 100 are separated by the second sealing system S20.

The first sealing system S10 is composed of a buffer section S11 that mainly buffers a fluid pressure (herein, an oil pressure), a main seal section S12 that mainly suppresses (prevents) leakage of a sealed liquid (herein, oil) in the hydraulic cylinder 100 to the outside, and a dust seal section S13 that mainly suppresses (prevents) entry of dust.

<First Sealing System>

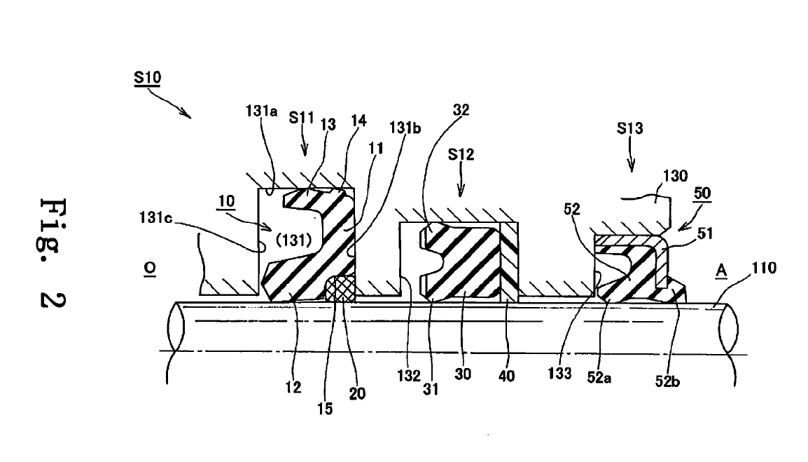

With reference to FIG. 2 in particular, the first sealing system S10 will be described in greater detail. FIG. 2 is a schematic cross-sectional view of the sealing system according to the embodiment of the present disclosure. An inner periphery of a shaft hole of the cylinder 130 is provided with a first annular groove 131, a second annular groove 132 that is provided on the air side A of the first annular groove 131, and an annular notch 133 that is provided further to the air side A. The buffer section S11 is provided in the first annular groove 131, the main seal section S12 is provided in the second annular groove 132, and the dust seal section S13 is provided in the annular notch 133.

The buffer section S11 is composed of a buffer ring 10 and a backup ring 20.

The main seal section S12 is composed of a packing 30 having an inner peripheral lip 31 and an outer peripheral lip 32, and a backup ring 40. In the present example, a U-packing having a U-shaped cross section and made of a rubber-like elastic material is used as the packing 30. The backup ring 40 made of a resin is provided on the air side A of the packing 30. With this, the inner peripheral end edge of the packing 30 is prevented from being protruded into a minute annular gap between the piston rod 110 and the cylinder 130.

The dust seal section S13 is composed of a dust seal 50 that comprises a metal ring 51 and a seal portion 52 made of a rubber-like elastic material and formed integrally with the metal ring 51. Note that the seal portion 52 has an oil lip 52a and a dust lip 52b.

With the compositions described above, by disposing the buffer ring 10 on the sealed fluid side O of the packing 30, it is possible to buffer the fluid pressure (the oil pressure) against the packing 30. In addition, by disposing the dust seal 50 on the air side A of the packing 30, it is possible to suppress the entry of a foreign matter (dust, dirt and the like) to the side of the packing 30 from the outside. Accordingly, it becomes possible to increase the durability of the packing 30.

<Buffer Ring>

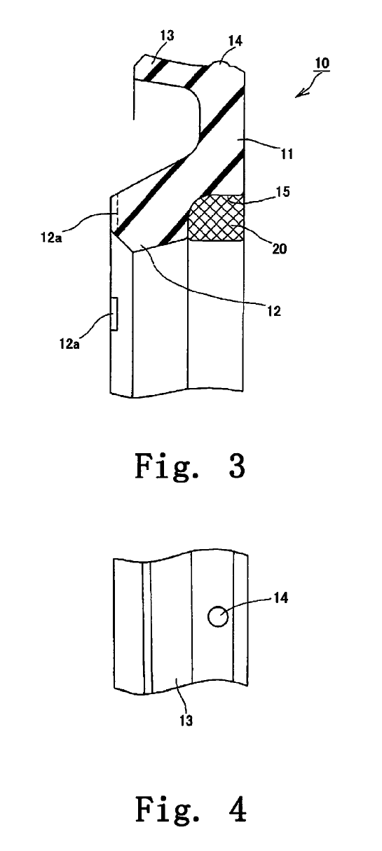

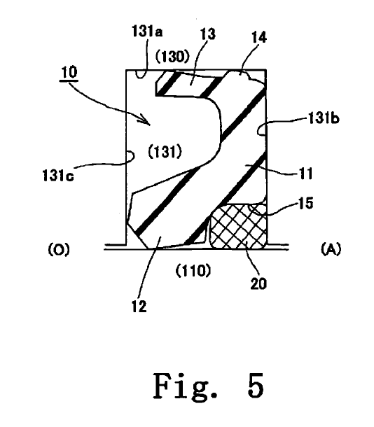

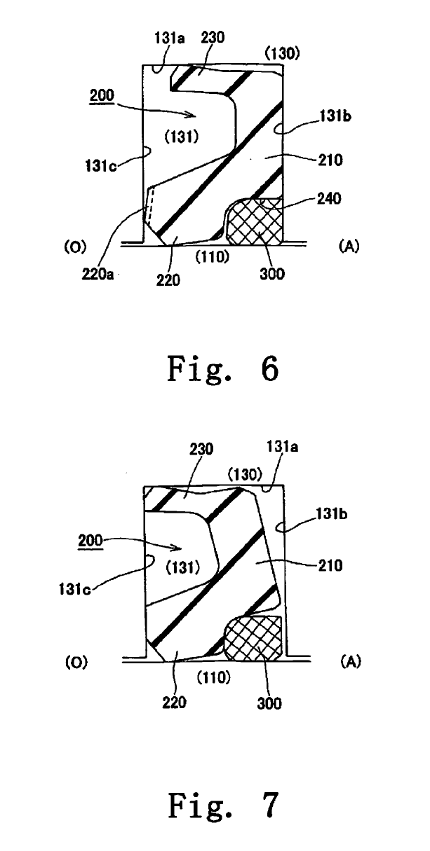

With reference to FIGS. 3 to 5 in particular, the buffer ring 10 according to the present example will be described in greater detail. FIG. 3 is a schematic cross-sectional view of the buffer ring 10 according to the example of the present disclosure. FIG. 4 is a view showing a part of an outer peripheral face of the buffer ring 10 according to the example of the present disclosure. FIG. 5 is a schematic cross-sectional view showing the fixed state of the buffer ring 10 according to the example of the present disclosure.

The buffer ring 10 according to the present example is composed of a rubber-like elastic material such as urethane rubber or NBR. The buffer ring 10 integrally comprises an annular body portion 11, an inner peripheral lip 12 that extends toward the sealed fluid side O from an inner peripheral end portion of the body portion 11, and an outer peripheral lip 13 that extends toward the sealed fluid side O and the outer peripheral side so as to be inclined from an outer peripheral end portion of the body portion 11.

The body portion 11 makes close contact with a side wall face 131b on the air side A of the first annular groove 131 when the fluid pressure on the sealed fluid side O is higher than the fluid pressure on the air side A. In addition, on the outer peripheral face of the body portion 11, a plurality of protrusions 14 that make close contact with a groove bottom face 131a of the first annular groove 131 are provided at intervals in a circumferential direction. In the present example, the plurality of protrusions 14 are provided at regular intervals in the circumferential direction. Note that the diameter of a virtual circle that passes the tips of all of the protrusions 14 can be made larger than the inner diameter of the groove bottom face 131a of the first annular groove 131 so that the protrusions 14 make close contact with the groove bottom face 131a in a state of being compressed. Or the diameter and the inner diameter can be set nearly equal so that the protrusions 14 make close contact with the groove bottom face 131a in a state of being not compressed.

The inner peripheral lip 12 is configured such that it extends toward the sealed fluid side O from the inner peripheral end portion of the body portion 11, and its inner peripheral end portion is slidable relative to the outer peripheral face of the piston rod 110. In addition, on the end portion on the sealed fluid side O of the inner peripheral lip 12, there is provided a groove 12a that secures a fluid channel even when the inner peripheral lip 12 is in a contact state with a side wall face 131c on the sealed fluid side O of the first annular groove 131.

The outer peripheral lip 13 is configured such that it extends toward the sealed fluid side O from the outer peripheral end portion of the body portion 11, and its outer peripheral end portion makes close contact with the groove bottom face 131a of the first annular groove 131. The outer peripheral lip 13 is configured so as to be smaller in thickness, lower in stiffness, and shorter in length than the inner peripheral lip 12.

In addition, an annular notch 15 is provided on the inner peripheral end edge on the air side A of the buffer ring 10. The backup ring 20 is fixed in the annular notch 15. With this, a part (the inner peripheral end edge) of the buffer ring 10 is prevented from being protruded into the minute annular gap between the piston rod 110 and the cylinder 130. Note that the backup ring 20 is composed of a resin material such as PTFE or the like.

As described above, in the buffer ring 10 according to the present example, the plurality of protrusions 14 provided on the outer peripheral face of the body portion 11 are in close contact with the groove bottom face 131a of the first annular groove 131. Consequently, even in a state in which the piston rod 110 is reciprocating or the pulsation of the oil pressure is occurring, the buffer ring 10 maintains a stable posture in the first annular groove 131 without falling over.

<Advantages of the Buffer Ring According to the Present Example>

According to the buffer ring 10 according to the present example, the plurality of protrusions 14 that make close contact with the groove bottom face 131a of the first annular groove 131 are provided on the outer peripheral face of the body portion 11 at intervals in the circumferential direction. Accordingly, it is possible to prevent the entire buffer ring 10 from falling in such a way as to tilt. Because of this, it is possible to stabilize the posture of the buffer ring 10 with respect to the first annular groove 131. Accordingly, it is possible to make the function of the buffer ring 10 be stably performed. With the advantages described above, it becomes possible to prevent a high pressure from acting against the packing 30, and increase sealing performance of the entire first sealing system S10.

### REFERENCE SIGNS LIST

10 buffer ring
11 body portion
12 inner peripheral lip
12a groove
13 outer peripheral lip
14 protrusion
15 notch
20 backup ring
30 packing
31 inner peripheral lip
32 outer peripheral lip
40 backup ring
50 dust seal
51 metal ring
52 seal section
52a oil lip
52b dust lip
100 hydraulic cylinder
110 piston rod
120 piston
130 cylinder
131 first annular groove
131a groove bottom face
131b side wall face
131c side wall face
132 second annular groove
133 notch
134, 135 port
A air side
O sealed fluid
S10 first sealing system
S11 buffer section
S12 main seal section
S13 dust seal section
S20 second sealing system

1. A buffer ring to buffer a pressure of a sealed fluid against a packing that seals an annular gap between a shaft and a housing reciprocating relative to each other, the buffer ring being fixed on a sealed fluid side of the packing and in an annular groove provided on an inner periphery of the housing, the buffer ring comprising:
an annular body portion that makes close contact with a side wall face of the annular groove;
an inner peripheral lip that extends toward a sealed fluid side from an inner peripheral end portion of the body portion, the inner peripheral lip including an inner peripheral end portion, the inner peripheral end portion of the inner peripheral lip being slidable relative to an outer peripheral face of the shaft; and
an outer peripheral lip that extends toward the sealed fluid side and an outer peripheral side so as to be inclined from an outer peripheral end portion of the body portion, the outer peripheral lip including an outer peripheral end portion, the outer peripheral end portion of the outer peripheral lip making close contact with a groove bottom face of the annular groove, the outer peripheral lip being lower in stiffness than the inner peripheral lip,
the body portion including an outer peripheral face, the outer peripheral face being provided with a plurality of protrusions that make close contact with the groove bottom face of the annular groove, the plurality of protrusions being located at intervals in a circumferential direction and at locations that are within a region of the outer peripheral face of the body portion and separated from an end face on a packing disposed side of the body portion.
